(19) United States
(12) Patent Application Publication
(10) Pub. No.: US 2015/0316237 A1
(43) Pub. Date: Nov. 5, 2015

(54) ADAPTER FOR CHANGING LED LIGHT BULBS

(71) Applicants: Joseph GURWICZ, Egg Harbor Twp, NJ (US); Michael ROSEN, Boca Raton, FL (US)

(72) Inventors: Joseph GURWICZ, Egg Harbor Twp, NJ (US); Michael ROSEN, Boca Raton, FL (US)

(21) Appl. No.: 14/457,871

(22) Filed: Aug. 12, 2014

Related U.S. Application Data
(60) Provisional application No. 61/987,175, filed on May 1, 2014.

(51) Int. Cl. F21V 19/00; B25B 13/48; F21V 21/36

(52) U.S. Cl. CPC F21V 19/001; F21V 21/36; B25B 13/48

(57) ABSTRACT

An adapter for changing LED light bulbs can have a threaded fitting for attachment to the pole of an existing light-bulb changer. The adapter has a body, preferably formed of a rigid material such as a rigid plastic. The body has multiple teeth to engage the spaces between the cooling fins of the LED light bulb. The light bulb can then be unscrewed from its socket and lowered using the pole and the adapter. A new light bulb can be placed on the teeth, raised, and screwed into the socket.

### REFERENCE TO RELATED APPLICATION

The present application claims the benefit of U.S. Provisional Patent Application No. 61/987,175, filed May 1, 2014, whose disclosure is hereby incorporated in its entirety into the present disclosure.

### FIELD OF THE INVENTION

The present invention is directed to an adapter for changing light bulbs and more particularly to an adapter for changing LED (light-emitting diode) light bulbs.

### Description of Related Art

Light-bulb changers are known in the art and allow a user to change a light bulb without using a step ladder or touching a hot bulb. A typical changer comprises a grabber for grabbing a light bulb, attached to a pole for allowing a user to reach the light bulb with the grabber. The grabber includes flexible fingers for engaging the light bulb and allowing the user to unscrew the light bulb. A changer can be sold with multiple grabbers for different sizes and shapes of light bulbs, each of them removably attachable to the pole with a threaded connection. The grabbers are designed for use with roughly spherical incandescent light bulbs, spotlight bulbs, and compact fluorescent light (CFL) bulbs.

In an unrelated development, LED light bulbs are increasingly popular, at least in part because of federal regulations. A typical LED light bulb, which can be designed to fit into the same socket as a traditional incandescent light bulb, is shown in FIGS. 1-3 as 100. The light bulb 100 includes a heat sink 102 of aluminum or a similar material around the lighting element. The heat sink has multiple cooling fins 104 (omitted from FIG. 1 for clarity, but shown in FIGS. 2 and 3) radiating from the axis A of the bulb 100; in many designs, the fins 104 extend to the front of the bulb 100 and are supported by a ring 106. The fins 104 define spaces 108 therebetween.

However, LED light bulbs are typically shaped differently from conventional incandescent, halogen, or compact fluorescent light bulbs. For example, the bulb 100 of FIGS. 1-3 has a flat face and a sharply sloping back. As a consequence, traditional changers do not work with many LED light bulbs. Because of the different shape, the flexible fingers of the grabber often cannot engage with the bulb, nor can they enter the spaces 108.

### SUMMARY OF THE INVENTION

It is therefore an object of the invention to provide a light-bulb changer for changing LED light bulbs.

To achieve the above and other objects, the present invention is directed to an adapter for changing LED light bulbs. The adapter can have a threaded fitting for attachment to the pole of an existing light-bulb changer. The adapter has a body, preferably formed of a rigid material such as a rigid plastic. The body has multiple teeth to engage the spaces between the cooling fins of the LED light bulb. The light bulb can then be unscrewed from its socket and lowered using the pole and the adapter. A new light bulb can be placed on the teeth, raised, and screwed into the socket.

The adapter can be designed for each type of LED light bulb and for the pole to which it is to be attached. The adapter has the correct number of teeth, and the correct length of each tooth, to engage the light bulb for removal. The teeth typically face directly forward, parallel to the axis of the adapter, to allow easy insertion of the teeth into the spaces and easy removal once the light bulb has been lowered from its socket. The adapter is also designed to attach to the pole; as a result, the adapter can have a conical, hemispherical, or similar shape.

Multiple such adapters can be sold together as a kit for changing multiple types of light bulbs. An adapter can be sold with a pole, with screw adapters for mounting on different types of poles, or separately.

### BRIEF DESCRIPTION OF THE DRAWINGS

A preferred embodiment of the invention will be set forth in detail with reference to the drawings, in which:

FIG. 1 is a perspective view showing the adapter according to the preferred embodiment being brought into engagement with a light bulb;

FIG. 2 is a view showing the interrelations among the parts of the adapter and light bulb of FIG. 1;

FIG. 3 is a side view showing the adapter and light bulb of FIG. 1 when they are engaged with each other; and

FIG. 4 is a perspective view showing a set of three adapters sized for different light bulbs according to a variation of the preferred embodiment.

### DETAILED DESCRIPTION OF THE PREFERRED EMBODIMENT

A preferred embodiment and variations thereof will be described in detail with reference to the drawings, in which like reference numerals refer to like elements or steps throughout.

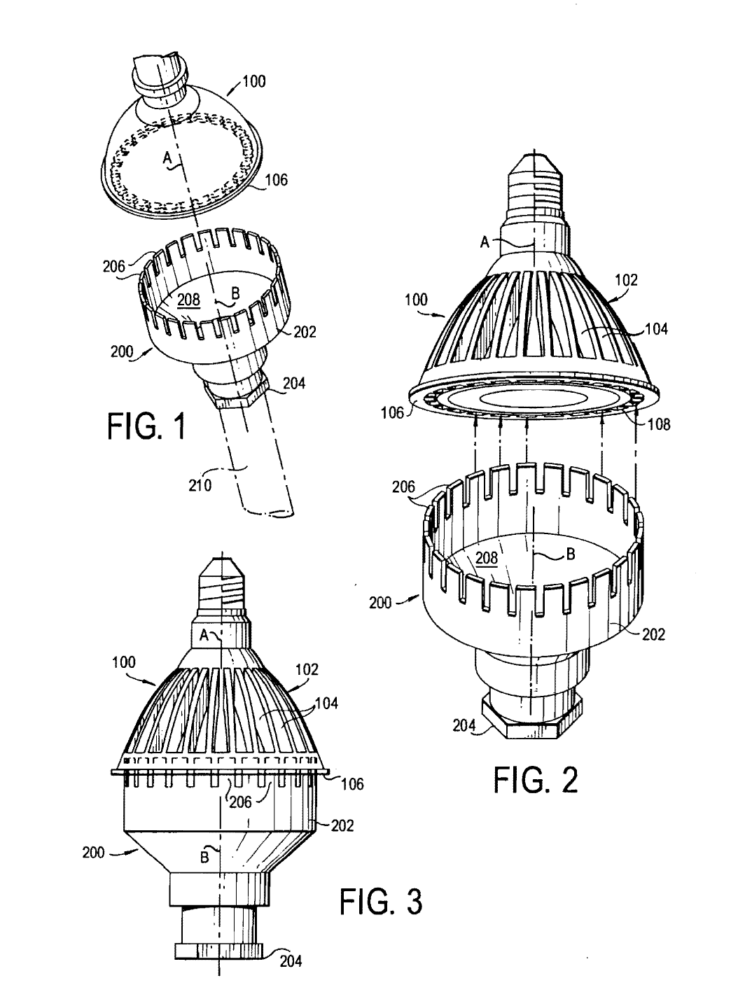

FIGS. 1-3 show an adapter 200 according to the preferred embodiment. Because the adapter is designed to be used with a particular light bulb, its proportions, including its diameter and the number and length of teeth, are selected for that particular light bulb,

The adapter 200 has a body 202. At one end of the body 202 is a mount 204, such as a threaded mount, designed to mount the adapter 200 onto the pole 210 of a light-bulb changer, which can be a light-bulb changer now on the market or yet to be introduced. At the other end are teeth 206 for engaging with the light bulb in a manner to be explained below. The teeth 206 extend parallel to the axis B of the adapter 200 for easy engagement and disengagement with the light bulb. Because the end with the mount 204 and the end with the teeth 206 typically have different diameters, the body 202 has a shape such as a cone or a hemisphere, although any other suitable shape can be chosen.

The adapter 200 can be made in any suitable way, such as by molding or by machining, and out of any suitable material, such as rigid plastic. It is contemplated that the body 202 will have an empty space 208 to reduce both the weight of the adapter 200 and the amount of material used; however, the body 202 could be solid if so desired.

FIG. 3 shows the engagement of the light bulb 100 and the adapter 200. The light bulb 100 and the adapter 200 are brought into a coaxial arrangement facing each other, and the teeth 206 are inserted into the spaces 108. By turning the adapter 200 (e.g., by turning the pole), the user turns the light bulb 100 to screw it into or unscrew it from the socket. Once the light bulb 100 is screwed in, the adapter 200 can simply be lowered, or once the light bulb 100 is unscrewed and lowered, it can simply be taken off of the adapter. As the light bulb 100 is raised or lowered, the body 202 and the teeth 206 support the light bulb 100 against falling off of the adapter 200.

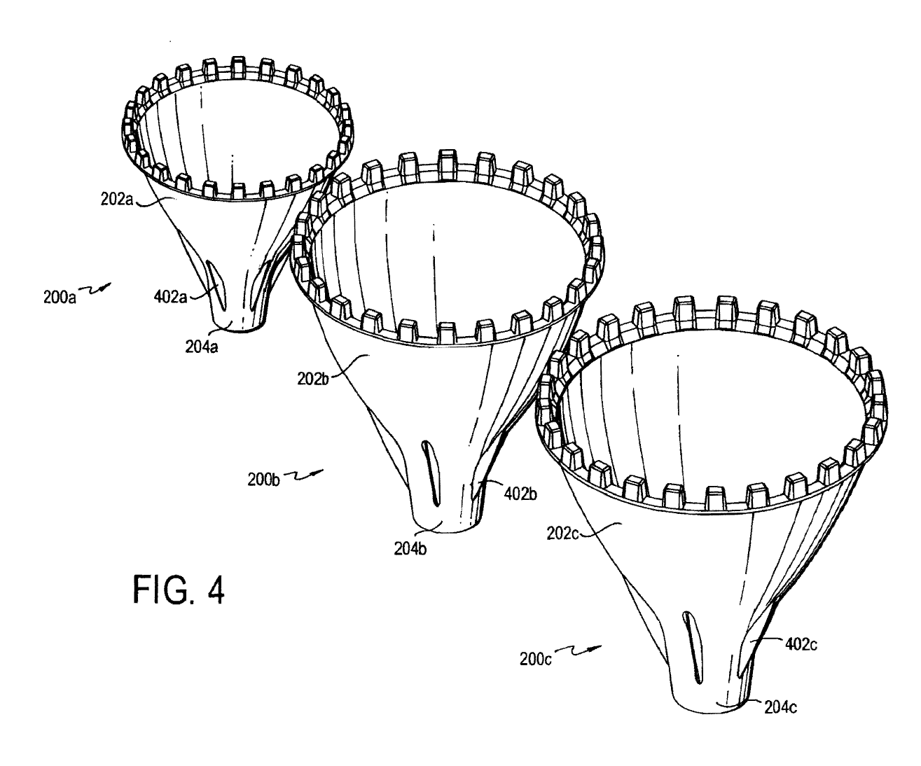

FIG. 4 is a perspective view showing three adapters 200a, 200b, 200c according to a variation of the preferred embodiment. The three adapters 200a, 200b, 200c are sized for different light bulbs. Of course, they can be packaged together or sold separately.

Each adapter 200a, 200b, 200c has a body 202a, 202b, 202c having curved sides. Ribs 402a, 402b, 402c are formed between the body 202a, 202b, 202c and the mount 204a, 204b, 204c. Otherwise, the adapters 200a, 200b, 200c can be formed like the adapter 200 of FIGS. 1-3.

While a preferred embodiment and variations thereof have been set forth above, those skilled in the art who have reviewed the present disclosure will readily appreciate that other embodiments can be realized within the scope of the invention. For example, the body and the teeth can have any proportions that are compatible with the light bulb to be changed, and the adapter can have any compatible number of teeth. Also, the invention can be used with an LED light bulb or any other similar device. Moreover, any shape of any component (such as the body 200, 200a, 200b, 200c) can be used as long as the adapter still works. Therefore, the present invention should be construed as limited only by the appended claims.

1. An adapter for changing a light bulb having a plurality of cooling fins, the adapter comprising:
a body having a proximal end and a distal end;
a mount at the proximal end of the body for attaching the adapter to a pole; and
a plurality of teeth extending from the distal end of the body, the plurality of teeth having a number and length adapted to enter spaces between the cooling fins of the light bulb.

2. The adapter of claim 1, wherein the mount comprises a threaded connector.

3. The adapter of claim 1, wherein the body has an axis, and wherein the teeth are parallel to the axis.

4. A method for removing a light bulb having a plurality of cooling fins from a socket, the method comprising:
(a) providing an adapter comprising:
a body having a proximal end and a distal end;
a mount at the proximal end of the body for attaching the adapter to a pole; and
a plurality of teeth extending from the distal end of the body, the plurality of teeth having a number and length adapted to enter spaces between the cooling fins of the light bulb;
(b) positioning the adapter such that the teeth are in the spaces between the cooling fins;
(c) unscrewing the light bulb by rotating the adapter; and
(d) removing the light bulb from the adapter.

5. The method of claim 4, wherein step (a) comprises mounting the adapter to a pole.

6. The method of claim 5, wherein the mount comprises a threaded connector for connection to the pole.

7. A method for installing a light bulb having a plurality of cooling fins in a socket, the method comprising:
(a) providing an adapter comprising:
a body having a proximal end and a distal end;
a mount at the proximal end of the body for attaching the adapter to a pole; and
a plurality of teeth extending from the distal end of the body, the plurality of teeth having a number and length adapted to enter spaces between the cooling fins of the light bulb;
(b) positioning the light bulb such that the teeth are in the spaces between the cooling fins;
(c) screwing the light bulb into the socket by rotating the adapter; and
(d) removing the adapter from the light bulb.

8. The method of claim 7, wherein step (a) comprises mounting the adapter to a pole.

9. The method of claim 8, wherein the mount comprises a threaded connector for connection to the pole.
